(19) United States
(12) Patent Application Publication
(10) Pub. No.: US 2005/0144991 A1
(43) Pub. Date: Jul. 7, 2005

(54) Reusable hasp-locking mechanism

(76) Inventors: Ramiro H. Bravo, Angola, IN (US); Scott F. Kiefer, Angola, IN (US); Jeffrey E. Warner, Fremont, IN (US); Craig B. Hamilton, Waterloo, IN (US)

Correspondence Address: BAKER & DANIELS, 205 W. JEFFERSON BOULEVARD, SUITE 250, SOUTH BEND, IN, 46601, US

(21) Appl. No.: 10/752,252

(22) Filed: Jan. 6, 2004

(51) Int. Cl. E05B 67/38; E05B 47/06

(52) U.S. Cl. 70/56; 70/283

(57) ABSTRACT

A locking mechanism for use on a hasp or other hardware of a door including a housing with an opening configured to receive the hasp, and a locking member that is removable from the locking mechanism during a normal unlocking operation. The locking member is insertable through at least a portion of the housing and the hasp into a locked position. The locking mechanism also includes a locking pin that is engageable with the locking member to lock the locking member in the locked position, and a spring biasing the locking pin in a first direction to lock the locking member. The locking member may have a first end and a second end, wherein the first end has a tapered surface. The tapered surface is engageable with the locking pin to push the locking pin in a second direction opposite the first direction so that the locking member may be manually inserted into the locked position. The locking member may be located predominantly within the housing when in the locked position. In one embodiment, the locking mechanism further includes a second spring, and the second spring biases the locking member along a longitudinal direction thereof when the locking member is in the locked position. The second spring may push the locking member out of the locked position when the locking pin is retracted. In one embodiment, the locking mechanism further includes an electro-mechanical device that retracts the locking pin to release the locking member from the locked position when actuated. The locking member may be manually inserted into the locked position.

### BACKGROUND OF THE INVENTION

The present invention relates to a locking mechanism, and in particular, to a reusable locking mechanism for use on a hasp or other door hardware of a cargo container, tractor trailer doors, rail car doors, or the like.

Many devices have been used to attempt to thwart tampering with or breaking into cargo containers. One of the most common prior art devices is a padlock. However, as padlocks are susceptible to being cut with bolt cutters, numerous other locking mechanisms or seals to indicate when a lock has been tampered with have been developed.

One such lock and seal is disclosed in U.S. Pat. No. 5,118,149. The '149 patent discloses a breakaway security seal including a pin or shaft having a top cap and a bottom cap. The breakaway seal is protected by a hasp protector including a shield to cover the shaft in order to deter cutting the shaft with bolt cutters. When it is desired to open the container, a special seal-removal tool is used to break this type of seal.

Another locking device is disclosed in U.S. Pat. No. 5,732,989. The locking device disclosed in the '989 patent utilizes a bolt that extends through the hasp on the door and a lock designed to secure the bolt on the hasp and prevent the bolt from being removed by a person who is not authorization to do so. In order to help prevent the bolt from being cut off the hasp, the locking device includes a lock body and an enlarged head that surround respective ends of the bolt that protrude beyond the hasp. A special tool is disclosed in the '989 patent for removing the locking device from the hasp.

U.S. Pat. No. 6,009,731 discloses several protective devices that may be used to further protect the locking device disclosed in the '989 patent. Yet another bolt seal protector is disclosed in U.S. Pat. No. 6,519,982, which is designed to protect a bolt seal and to fit around a door keeper bar assembly.

### SUMMARY OF THE INVENTION

In one embodiment, the invention includes a locking mechanism for use on a hasp or other hardware of a door. The locking mechanism has a housing with an opening configured to receive the hasp or hardware and a locking member that is removable from the locking mechanism during a normal unlocking operation. The locking member is insertable through at least a portion of the housing and the hasp into a locked position. The locking mechanism also includes a locking pin that is engageable with the locking member to lock the locking member in the locked position, and a spring biasing the locking pin in a first direction to lock the locking member.

In one embodiment, the locking member has a first end and a second end, and the first end has a tapered surface. The tapered surface is engageable with the locking pin to push the locking pin in a second direction opposite the first direction so that the locking member may be manually inserted into the locked position. The locking member may be located predominantly within the housing when in the locked position.

In one embodiment, the locking mechanism further includes a second spring biasing the locking member along a longitudinal direction thereof when the locking member is in the locked position. The second spring may push the locking member out of the locked position when the locking pin is retracted.

In another embodiment, the locking member includes a groove, and a portion of the locking pin is located in the groove when the locking member is in the locked position. A portion of the locking pin that is located in the groove may have a radiused surface.

In one embodiment, the locking mechanism further includes an electro-mechanical device that retracts the locking pin to release the locking member from the locked position when actuated. The locking member may be manually inserted into the locked position.

In another feature of the invention, an embodiment is provided wherein the locking pin is substantially perpendicular to the locking member when the locking member is in the locked position. The locking mechanism may further include a lock body having bores meeting in a substantially T-shaped configuration, and the locking pin may engage the locking member in the bores when the locking member is in the locked position.

It is also a feature of the invention to provide another embodiment of a locking mechanism for use on a hasp or other hardware of a door that includes a housing having an opening configured to receive the hasp or hardware and a locking member that is insertable through at least a portion of the housing and hasp or hardware into a locked position. The locking mechanism also includes a locking pin that is engageable with the locking member to lock the locking member in the locked position and a first spring biasing the locking pin in a first direction to lock the locking member. A second spring may also be provided that biases the locking member along a longitudinal axis thereof when the locking member is in the locked position.

The second spring may push the locking member to a position where it may be removed when the locking pin is retracted.

The locking mechanism may also include an electro-mechanical device that retracts the locking pin to release the locking member from the locked position when actuated.

In one embodiment, the locking member may be manually inserted into the locked position. The locking member may have first and second ends wherein the first end is biased by the second spring when the locking member is in the locked position. The first end may include a tapered surface, such that the tapered surface is engageable with the locking pin to push the locking pin in a second direction, opposite the first direction, so that the locking member may be manually inserted into the locked position.

It is also a feature of the invention that in one embodiment, the locking member includes a locking feature, and the locking pin is engaged with the locking feature when the locking member is in the locked position. The second spring may push the locking member so that the locking feature is in engagement with the locking pin when the locking member is in the locked position. In one embodiment, the locking pin is substantially perpendicular to the locking member when the locking member is in the locked position.

Another feature of the invention is to provide an embodiment of a locking mechanism for use on a hasp of a door that includes a housing, a locking member that is insertable through the hasp into a locked position locking the door; and an electro-mechanical device mounted to the housing. When the electro-mechanical device is actuated, the locking member may be removed from the locked position, and the locking member may be inserted into the locked position without actuating the electro-mechanical device.

The locking member may be removable from the locking mechanism or it is possible to keep the locking member attached to the locking mechanism by using a tether, wire spring clip or other mechanism.

In one embodiment, the locking mechanism further includes a battery mounted in the housing for providing electric power for actuating the electro-mechanical device.

In another embodiment, the locking mechanism includes a locking pin that is engageable with the locking member when the locking member is in the locked position, and the locking pin may be retracted by the electro-mechanical device. The locking mechanism may further include a spring that biases the locking pin to lock the locking member. In one embodiment, the locking mechanism further includes a second spring, and the second spring biases the locking member along a longitudinal axis thereof when the locking member is in the locked position. The second spring may push the locking member out of the locked position when the locking pin is retracted.

It is yet another feature of the invention to provide an embodiment of a locking mechanism for use on a hasp or other hardware of a door that includes a housing and a locking member that is removable from the locking mechanism. The locking member is insertable through the hasp or hardware into a locked position The locking mechanism also includes a locking pin that is engageable with the locking member to lock the locking member in the locked position and a spring that biases the locking member along a longitudinal axis thereof when the locking member is in the locked position.

In one embodiment, the spring pushes the locking member out of the locked position for removal thereof when the locking pin is retracted.

In a different embodiment, the locking mechanism further includes an electro-mechanical device mounted to the housing and connected to the locking pin so that the locking pin is retracted when the electro-mechanical device is actuated. The locking mechanism may further include a battery mounted in a housing, wherein the battery provides electrical power for actuating the electro-mechanical device. The locking member may also have a first end and a second end, wherein the first end has a tapered surface that is engageable with the locking pin to push the locking pin to a location so that the locking member may be manually inserted into the locked position. The locking mechanism may further include an additional spring that biases the locking pin to lock the locking member, and the locking member may have a locking feature wherein the locking pin engages the locking feature when the locking member is in the locked position.

In one embodiment, the housing of the locking mechanism includes a base and a cover, and the base has an opening configured to receive the hasp or hardware. The housing may also include a side wall and at least one internal flange, wherein the side wall and the flange each have a hole configured to receive the locking member.

The locking member may be a bolt, or alternately, the locking member may be an end member attached to a cable. If the locking mechanism uses a cable or other flexible materials such as Kevlar™, fiber optic cables, etc., a portion of the cable may be contained in the locking mechanism, and a length of the cable used to lock the door may be adjusted by pulling some of the cable from inside the locking mechanism. The cable may be locked so that an additional length cannot be pulled from the locking mechanism when the end member is inserted into the locked position. The locking mechanism may include a gripping mechanism that locks the cable when the locking member is inserted into the locked position.

### BRIEF DESCRIPTION OF THE DRAWINGS

The above-mentioned and other features of this invention and the manner of obtaining them will become more apparent and the invention itself will be better understood by reference to the following description of embodiments of the present invention taken in conjunction with the accompanying drawings, wherein:

FIG. 1 is a perspective view of reusable hasp-locking mechanisms according to one embodiment of the present invention mounted on hasps of a door.

FIG. 2 is a perspective view similar to that of FIG. 1 with the covers of the locking mechanisms removed.

FIG. 2A is an enlarged perspective view of one of the locking mechanisms removed from the door.

FIG. 3 is a partly exploded perspective view of the locking mechanisms shown in FIG. 1.

FIG. 4 is a perspective view of a portion of one of the locking mechanisms of FIG. 1 with part of a lock body cut away and a locking bolt ready to be inserted in the locking mechanism.

FIG. 5 is a cross-sectional view taken along line 5-5 in FIG. 4 and with the solenoid shown in phantom lines.

FIG. 6 is a cross-sectional view along the same plane as FIG. 5 with the bolt partially inserted into the locking mechanism.

FIG. 7 is a cross-sectional view along the same plane as FIG. 5 with the bolt inserted into the locking mechanism into a locked position.

FIG. 8 is a cross-sectional view along the same plane as FIG. 5 showing the actuating mechanism in the open position to release the bolt.

FIG. 9 is a side view of the bolt.

FIG. 10 is a plan view of a locking pin used in the locking mechanism.

FIG. 11 is a side view of the locking pin shown in FIG. 10.

FIG. 12 is a perspective view of a portion of a locking mechanism according to another embodiment of the invention with part of the lock body cut away and a locking bolt ready to be inserted into the locking mechanism.

FIG. 13 is a cross-sectional view taken along line 13-13 in FIG. 12.

FIG. 14 is a perspective view of a reusable locking mechanism according to yet another embodiment of the invention with the cover modified to be mounted to a vertical stanchion of a door.

FIG. 14A is an enlarged perspective view of the locking mechanism of FIG. 14.

FIG. 15 is a perspective view of still another embodiment of a locking mechanism according to the present invention having a flexible cable.

FIG. 16 is a cross-sectional view of the locking mechanism of FIG. 15 taken along a line similar to line 5-5 in FIG. 4 and showing the cable having an adjustable length.

FIG. 17 is a cross-sectional view taken along the same line as FIG. 16 with a locking member of the cable inserted in a lock body and the cable length locked.

Corresponding reference characters indicate corresponding parts throughout the several views. Although the drawings represent embodiments of the present invention, the drawings are not necessarily to scale and certain features may be exaggerated in order to better illustrate and explain the present invention. The discussion that follows illustrates certain embodiments of the invention and is not to be construed as limiting the scope of the invention in any manner.

### DETAILED DESCRIPTION OF EMBODIMENTS OF THE INVENTION

The embodiments disclosed below are not intended to be exhaustive or to limit the invention to the precise forms disclosed in the detailed description. Rather, the embodiments are chosen and described so that others skilled in the art might utilize their teachings.

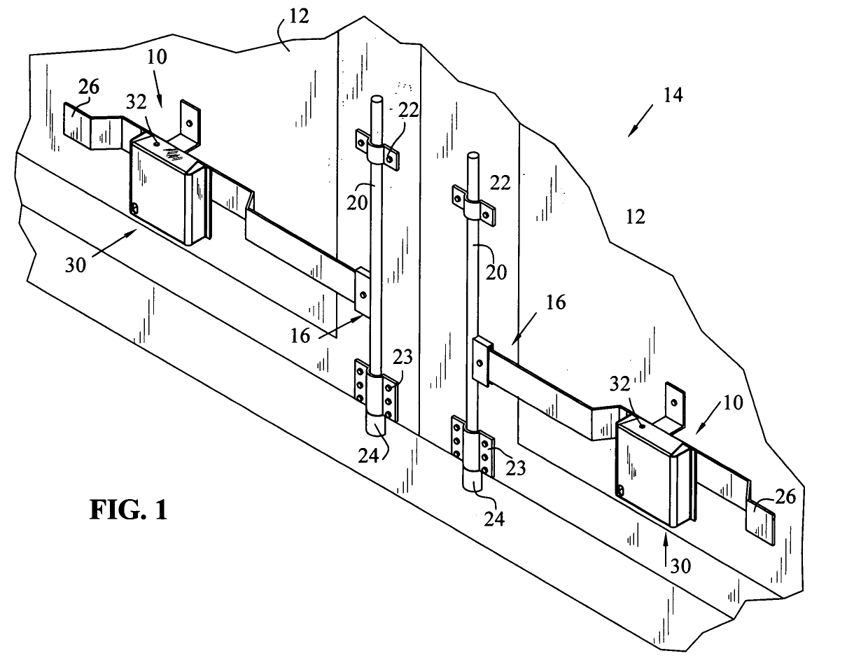

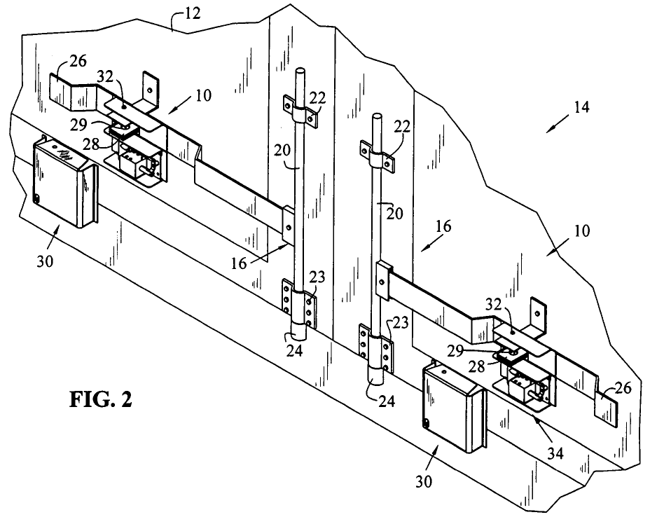

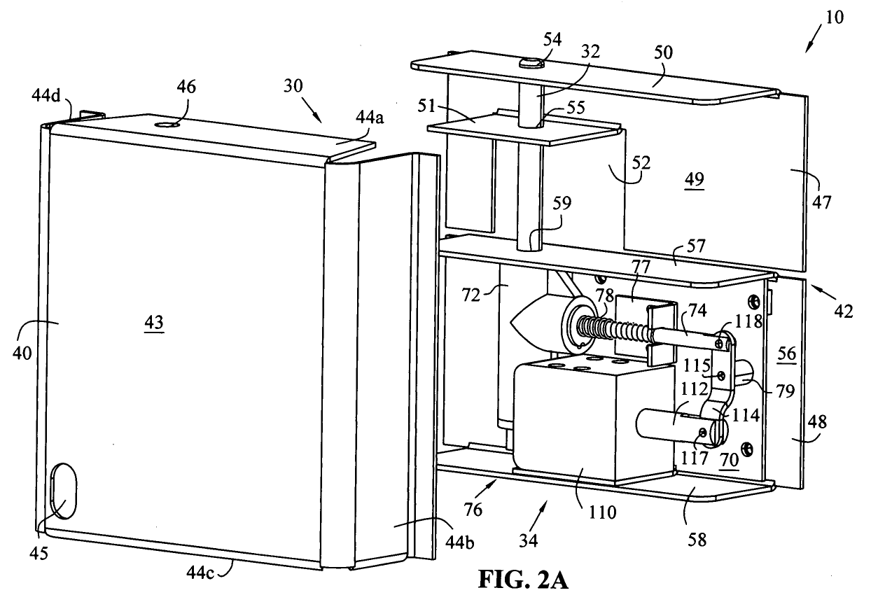

Referring to FIGS. 1-3, a pair of locking mechanisms generally indicated as 10 are shown for locking doors 12 on a vehicle or cargo container generally indicated as 14. In the embodiment shown, each door 12 includes a securing mechanism generally indicated as 16, which is well known. Each securing mechanism has a vertically moveable stanchion 20, mounting brackets 22, 23, a striker 24, a handle 26 and a hasp mechanism 28 (FIGS. 2 and 3). Hasp mechanisms 28 each include lock receiving holes 29 for use in locking securing mechanism 16 to prevent doors 12 from being opened by an unauthorized person. It should be realized that only one locking mechanism 10 may be required if one of the doors overlaps the other as is common so that the overlapped door cannot be opened unless the other door is opened first.

Locking mechanism 10 includes a housing generally indicated as 30, a locking bolt or member 32, and a securing and releasing device generally indicated as 34 that secures and subsequently releases bolt 32. Housing 30 may be made out of a suitable protective metal and cast, stamped, forged and/or bent and welded into the desired configuration. Housing 30 may also be molded from a suitable polymer. In the embodiment shown, housing 30 includes a cover 40 and a base generally indicated as 42. Cover 40 has a front face 43 and side flanges 44a-d extending downwardly therefrom (FIG. 2A). Front face 43 includes an opening 45 for receipt of an electronic plug (not shown), and side flange 44a has a hole 46 configured and sized to receive locking bolt 32.

Base 42 of housing 30 includes a first portion 47 and a second portion 48. First portion 47 includes a back 49, a side extension 50, an inner extension 51, and a hasp receiving area 52. Side extension 50 and inner extension 51 extend generally perpendicular to back 49 and have holes 54, 55, respectively, therethrough. Holes 54, 55 are aligned with one another and sized for receipt of locking bolt 32. Second portion 48 includes a back 56 and extensions 57, 58 extending substantially perpendicular to back 56 and parallel to extension 50, 51. Extension 57 has a hole 59 extending therethrough. Hole 59 is aligned with holes 54, 55 in first portion 47 and sized to receive locking bolt 32.

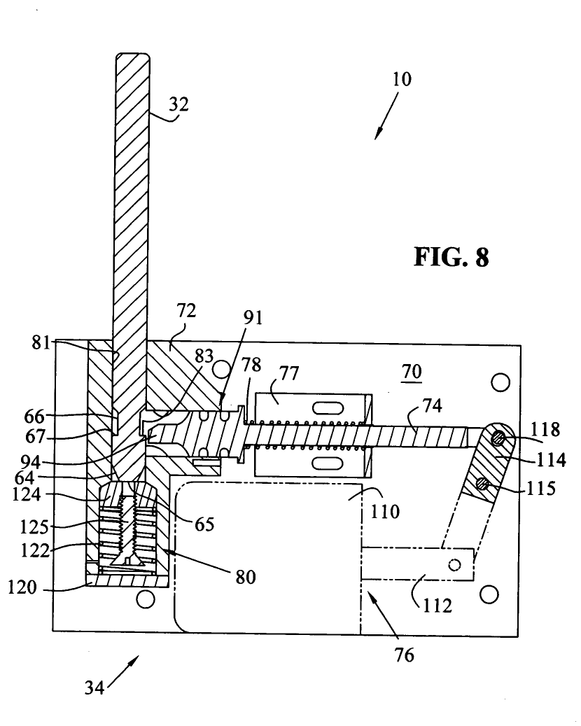

Locking bolt 32, as shown in FIG. 9, has a generally cylindrical configuration and extends along an axis A. Locking bolt 32 includes a first end generally indicated as 60 and a second opposite end generally indicated as 62. First end 60 includes a circumferential taper 64 extending back from a tip 65. Locking bolt 32 also includes a locking feature in the form of the circumferential slot or groove 66 set slightly back from taper 64 along axis A. The forward portion of circumferential slot 66 includes a shoulder or engagement surface 67, and the back portion includes a radiused or chamfer surface 68.

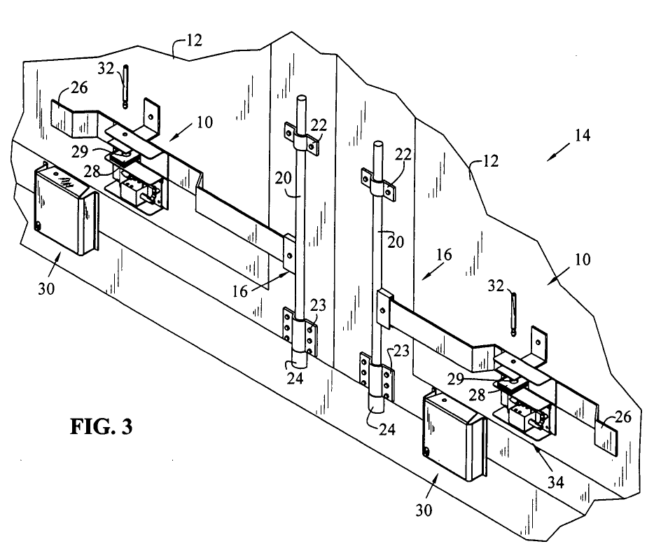

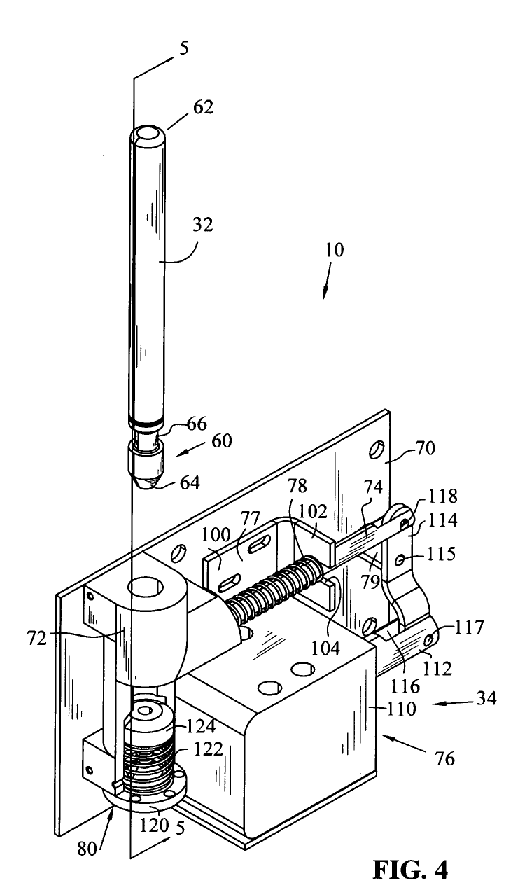

Referring now to FIG. 4, securing and releasing device 34 includes a base plate 70, a lock body 72, a locking pin generally indicated as 74, and an actuating mechanism generally indicated as 76 for moving the locking pin. Device 34 also includes a bracket 77 for positioning locking pin 74, a spring or biasing member 78 for biasing the locking pin, a shaft 79 and a biasing apparatus 80 for biasing bolt 32 along the longitudinal axis thereof as described below. As shown in FIGS. 5-8, lock body 72 has a generally T-shaped configuration with a through bore 81, a counterbore 82 of an increased diameter extending partially through bore 81, and an intersecting bore 83 that is approximately perpendicular to and intersects bore 81.

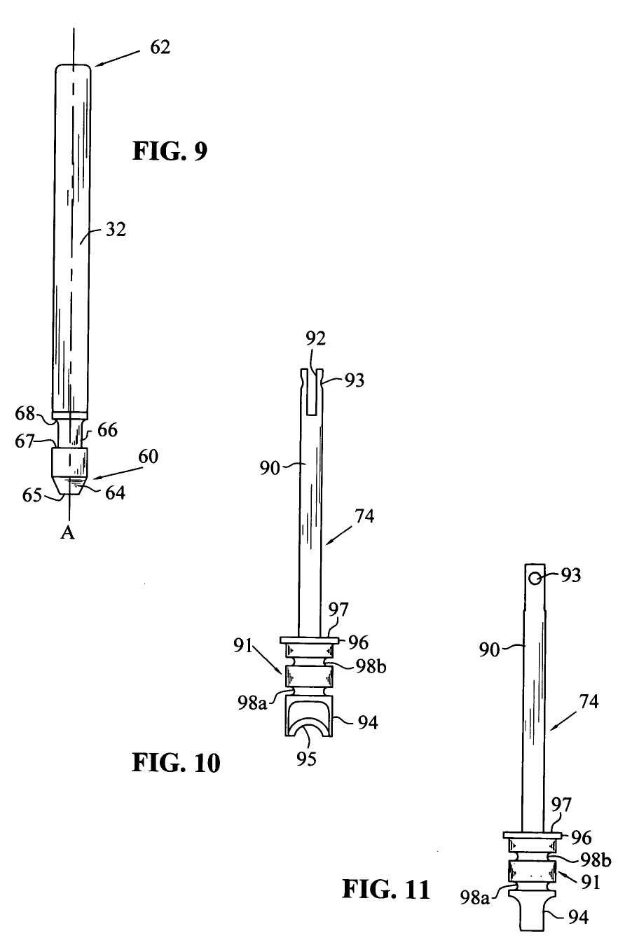

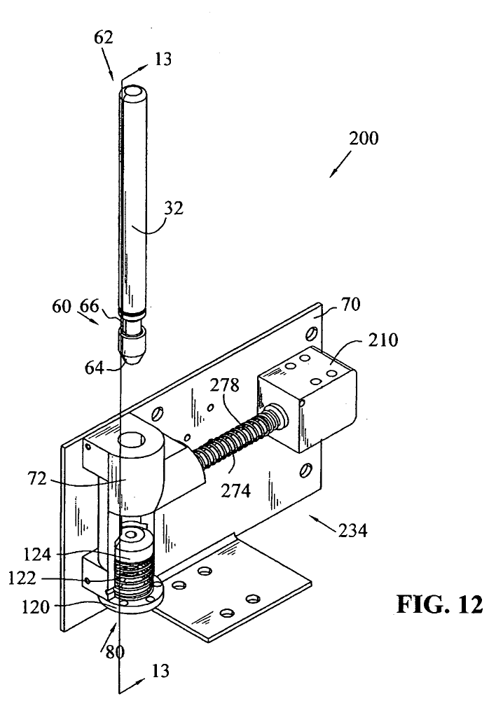

Now referring to FIGS. 10 and 11, the details of locking pin 74 are shown. Locking pin 74 includes an elongated shaft 90 and a head generally indicated as 91 attached at one end of the shaft. Shaft 90 has a slot 92 extending inward from the end opposite head 91 and through the width of the shaft. Shaft 90 also has a mounting hole 93 extending through both sides of shaft 90 adjacent the slot. Head 91 of pin 74 includes an engagement end 94 having a curved portion 95 sized to fit into and mate with circumferential groove 66 of bolt 32. Head 91 also has a circumferential shoulder 96 in order to limit movement of the locking pin in a direction along the length of the shaft and an end surface 97 where head 91 meets shaft 90. Additionally, head 91 includes a pair of circumferential grooves 98a, 98b that are configured to receive a sealing member (not shown) such as an O-ring.

As shown in FIG. 4, bracket 77 has a generally L-shaped configuration having a leg 100 attached to base plate 70 and another leg 102 extending perpendicularly upward from base plate 70. Leg 102 has a slot 104 extending inwardly from the outer end thereof that is sized and configured to receive locking pin 74.

In the embodiment shown, biasing member 78 is a compression coil spring. Spring 78 is located around shaft 90 of locking pin 74 and extends between leg 102 of bracket 77 and end surface 97 of head 91.

In the embodiment shown, actuating mechanism 76 is an electro-mechanical device such as a solenoid 110 (FIGS. 2A and 4), which is well known. Actuating mechanism 76 also includes an armature extension 112 extending from solenoid 110. Armature extension 112 is drawn further into the solenoid when the solenoid is energized. Actuating mechanism 76 further includes a connecting member 114 that pivots on shaft 79 about a pivot point 115. Armature extension 112 has a slot 116 at the outermost end thereof, and one end of connecting member 114 is located in slot 116 and connected to armature extension 112 at a connection 117 that enables connecting member 114 to pivot relative to armature extension 112. The other end of connecting member 114 is located in slot 92 of locking pin 74 and is connected to the locking pin at a connection 118 that permits connecting member 114 to also pivot relative to locking pin 74.

Biasing apparatus 80 is located in counterbore 82 of lock body 72, and in the embodiment shown, includes a cap 120, a coil compression spring 122, a bolt engaging member 124, and an adjusting screw 125 (FIGS. 4-8).

To assemble locking mechanism 10, lock body 72, bracket 77, shaft 79 and solenoid 110 are all mounted to base plate 70 using bolts, screws, adhesives, or other known fastening techniques. Biasing apparatus 80 is inserted into counterbore 82 such that cap 120 abuts against lock body 72 adjacent to the end of counterbore 82. Cap 120 may be sealed to lock body 72 using an adhesive, by welding, or using other known techniques to secure the members and provide a moisture resistant seal.

Spring 78 is placed about the shaft 90 of locking pin 74, and head 91 is inserted into intersecting bore 83. Shaft 90 is also placed within slot 104 of bracket 77 such that spring 78 is compressed between leg 102 of bracket 77 and end surface 97 of head 91. As shown in FIG. 5, spring 78 biases head 91 of locking pin 74 into intersecting bore 83 such that the normal state of the locking pin is in the locked position with circumferential shoulder 96 bearing against lock body 72 adjacent the end of intersecting bore 83.

In assembling the actuating mechanism 76, connecting member 114 is connected to shaft 79 at pivot point 115 using a pin, rivet, or other known connection that will enable connecting member 114 to pivot about shaft 79. The ends of connecting member 114 are placed respectively in slot 116 of armature extension 112 and slot 92 of locking pin 74 and connected thereto at connections 117 and 118, respectively, using pins, rivets, or other known connections that will allow connecting member 114 to pivot relative to armature extension 112 and locking pin 74.

Once assembled, securing and releasing device 34 is mounted to back 56 of portion 48 of housing 30 using bolts, screws, adhesive or other known joining techniques. Device 34 is located on portion 48 between extensions 57, 58 and positioned such that bore 81 in lock body 72 is aligned with hole 59 on extension 57. Portions 47 and 48 of base 42 of housing 30 are joined to one another along one side of backs 49 and 56, respectively. The portions may be joined by welding or other known joining techniques. Cover 30 can then be placed over base 42, and the whole unit is sealed together using a known sealing technique such as welding or adhesives. Any seams or other open areas that may provide a leak path for moisture to gain access to actuating mechanism 76 can be sealed using known sealants or caulk. It should be noted, that when locking mechanism is assembled, hole 46 in cover 40, hole 54 in extension 50, hole 55 in extension 51, and hole 59 in extension 57 are all aligned with one another such that locking bolt 32 may be inserted through the holes into bore 81 of lock body 72. An electrical connector (not shown) configured to mate with a connector on a control unit (not shown) may be placed in opening 45 to provide a direct electrical control input to actuation mechanism 76. At this point, the locking mechanism is ready for use to lock the hasps of a cargo door.

In operation, locking mechanism 10 may be installed on hasps 28 of doors 12 without the need to actuate mechanism 76, and without any special tools or security codes. The locking mechanism is installed by placing hasp receiving area 52 over hasp mechanism 28 prior to locking bolt 32 being installed. Locking mechanism 10 is placed over hasp mechanism 28 such that holes 46, 54, 55 and 59 of housing 30 are aligned with lock receiving holes 29 of hasp mechanism 28. End 60 of bolt 32 is then inserted through holes 46, 54, 55, 29, and 59, respectively and into bore 81 of lock body 72.

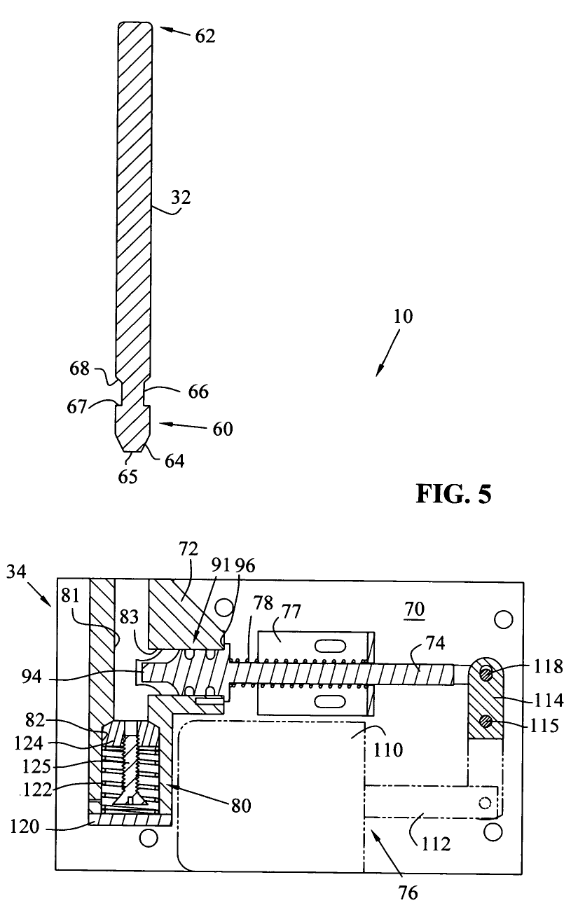

Upon continued insertion of locking bolt 32, circumferential taper 64 will contact engagement end 94 of locking pin 74, as shown in FIG. 6, wherein taper 64 acts as a cam surface to push head 91 of locking pin 74 partially out of intersecting bore 83. This further compresses spring 78 between leg 102 of bracket 77 and end surface 97 of head 91. It should be noted that pivot point 115 and connections 117 and 118 will pivot about respective pivot points when locking pin 74 is pushed in a direction to the right in FIG. 6.

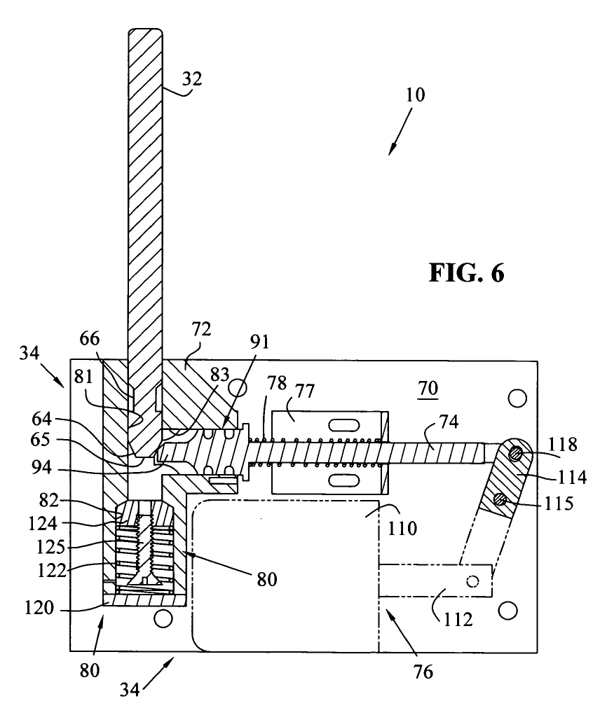

As locking bolt 32 is inserted further into bore 81, tip 65 will contact engagement member 124 of biasing apparatus 80, thereby causing member 124 to move downwardly and compress spring 122. When locking bolt 32 is inserted far enough so that engagement end 94 of locking pin 74 is aligned with circumferential groove 66, spring 78 pushes locking pin 74 toward locking bolt 32 so that end 94 engages groove 66 of bolt 32 (FIG. 7). In this position, locking bolt 32 cannot be removed, and engaging member 124 of biasing apparatus 80 will also be biasing bolt 32 along its axis A in a direction opposite from which it was inserted. However, biasing apparatus 80 can only push bolt 32 backward a limited distance as shoulder 67 of groove 66 encounters engagement end 94 of locking pin 74 to prevent the bolt from being pushed back any farther. At this point, locking mechanism 10 is fully engaged and locking the respective hasp mechanism 28 of door 12. It should also be noted that the length of bolt 32 should be sized so that when it is in the locked position as described, end 62 will be approximately flush with side flange 44a of cover 40. Since bolt 32 does not protrude from housing 30 when the bolt is in the locked position, and the hosing is completely sealed as discussed above, bolt 32 is not accessible to be pulled on, tampered with, or cut without destroying housing 30.

When it is desired to remove locking mechanism 10, it is necessary to actuate mechanism 76. This may be done by using an appropriate control and/or coded device (not shown) that may be plugged into an electrical connector (not shown) contained in opening 45 of cover 40 or by using a radio frequency or other type of remote control. Possession of the control device for actuating mechanism 76 should be restricted to individuals authorized to open the locking mechanism.

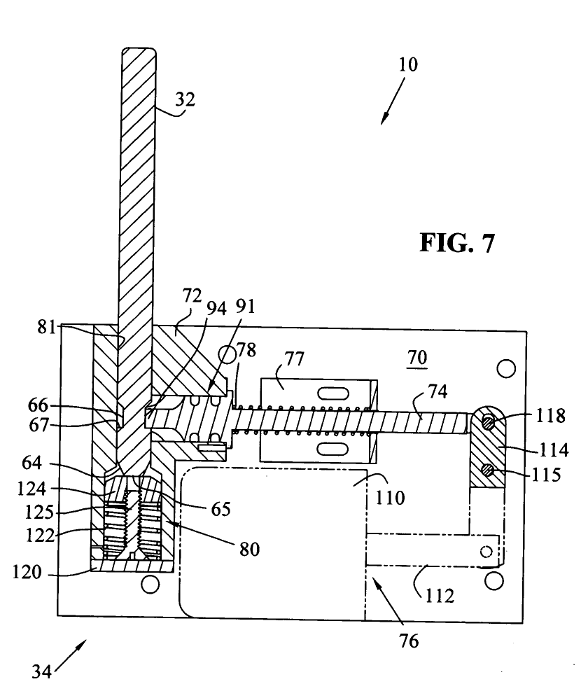

With input from the control device, solenoid 110 will be energized with power provided from batteries (not shown) contained in housing 30 or through lead lines (not shown) from a remote electrical power source (not shown). When solenoid 110 is energized, it will pull armature extension 112 further inside and thereby pull down the end of connecting member 114 attached to the armature extension. As connecting member 114 is mounted to and pivots about pivot point 115 of shaft 79, the opposite end of connecting member 114 will pull on locking pin 74 so that it moves to the right as shown in FIG. 8. This further compresses spring 78 and pulls head 91 partially out of bore 83 of lock body 72. This will cause engagement end 94 to be pulled out of groove 66 of bolt 32. Once engagement end 94 is free of groove 66, engaging member 124 of biasing apparatus 80 will push locking bolt 32 partially back out of bore 81 (FIG. 8). This pushes end 62 slightly out of hole 46 above side flange 44a. As such, bolt 32 can be pulled out of bore 81 and through holes 59, 29, 55, 54 and 46. The locking mechanism 10 may then be removed from hasp mechanisms 28 so that doors 12 may be opened. The above described embodiment can be reused in the manner set forth above to secure future loads of cargo.

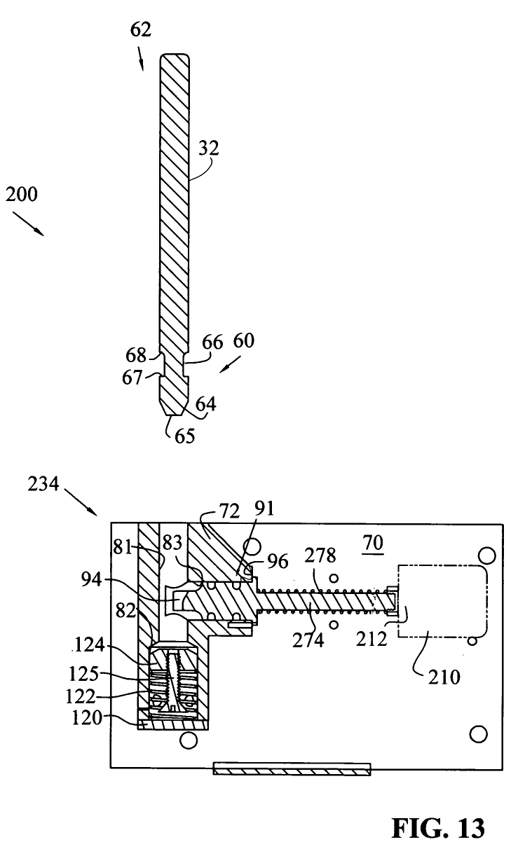

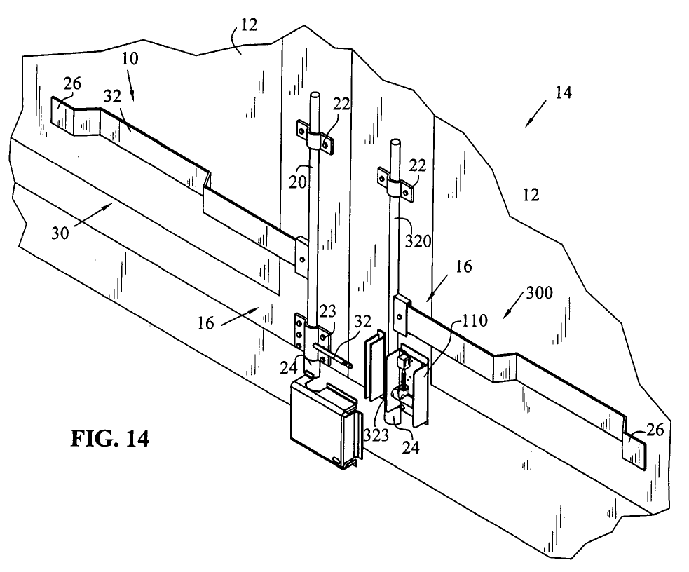

Referring now to FIGS. 12 and 13, an alternate embodiment locking mechanism is generally indicated as 200. Locking mechanism 200 includes a solenoid 210, and an armature extension 212 as part of a securing and releasing device 234. Securing and releasing device 234 also includes a locking pin 274 and spring or biasing member 278. Locking mechanism 200 is similar in other aspects to locking mechanism 10 and functions similarly, except that armature extension 212 is connected directly to pin 274 instead of being offset from one another and connected by connecting member 114. Locking pin 274 may be threadably or otherwise connected to armature extension 212. In addition, locking pin 274 and armature extension 212 may be made integral with one another out of a singular piece of ferrous material. Alternately, the locking pin and armature extension may be made from a single piece of a non-magnetic material with some ferrous material added in the portion of the locking pin/armature extension combination that extends within solenoid 210.

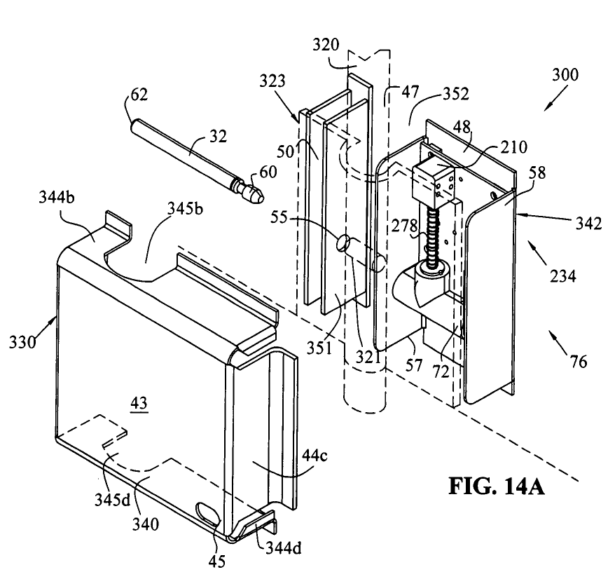

Another embodiment of a locking mechanism is shown generally indicated as 300 in FIGS. 14 and 14A. It should be noted that in FIG. 14, doors 12 are shown within an overlapping arrangement as discussed above so that only one locking mechanism 300 is required as the edge of the door with the locking mechanism overlaps the edge of the other door. In the embodiment shown, the securing and releasing device of locking mechanism 300 is similar to securing and releasing device 234 of locking mechanism 200. However, locking bolt 32 is inserted horizontally through a hole 321 that extends through a modified vertical stanchion 320 and a mounting bracket 323 as opposed to being inserted vertically through hasp mechanism 28 as discussed with the previous embodiments. A modified housing that is shown generally indicated as 330 is provided in order to accommodate stanchion 320 and mounting bracket 323. Housing 330 includes a cover 340 wherein side flanges 344b, 344d include openings 345b, 345d, respectively, for receipt of stanchion 320 and mounting brackets 323. Locking mechanism 300 also includes a base 342 including an inner extension 351 and stanchion receiving area 352. It should be noted that inner extension 351 and stanchion receiving area 352 extend completely across the width of base 342 unlike inner extension 51 and hasp receiving area 52 of housing 30, which extend only partially across base 42. When cover 340 is assembled with base 342, openings 345b, 345d align with stanchion receiving area 352. Also, when the housing is assembled, inner extension 351 and extension 57 are sealingly connected with cover 340 to prevent moisture and other contaminants from affecting securing and locking device 234.

It should also be appreciated that locking mechanism 10 or 200 may also be used with stanchion 320 and mounting bracket 323 having hole 321 therethrough. To use locking mechanism 10 or 200 in this manner, side extension 50 of base 42 is placed adjacent stanchion 320 and mounting bracket 323 with hole 54 aligned with hole 321. To use the locking mechanisms in this manner, a longer modified locking bolt (not shown) would be required having an enlarged head at end 62 that is larger in diameter than hole 321. In this manner, stanchion 320 would be locked in place between the enlarged head at end 62 of the locking bolt and side extension 50 when the first end 60 of the locking bolt is inserted and locked in securing and releasing device 34 or 234.

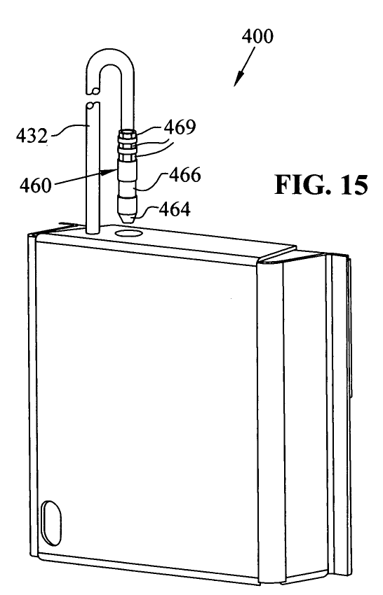

Another embodiment of a locking mechanism is shown generally as 400 in FIGS. 15-17. Locking mechanism 400 includes a flexible cable 432 and a modified securing and releasing device 434. Flexible cable 432 has a first end 460 and a second end 462. First end 460 has a locking configuration similar to end 60 on bolt 32 of locking mechanism 10 and 200 and includes a circumferential taper 464 and a circumferential slot or groove 466. First end 460 also includes crimped regions 469 for securing first end 460 on cable 432. Second end 462 includes an enlarged head 462a for reasons described below.

Locking mechanism 400 also has a modified lock body generally indicated as 472 that includes an axially bore 481 extending therethrough substantially parallel to bore 81. Axially bore 481 receives cable 432 and includes a gripping device or mechanism 484 that is pivotally connected to biasing apparatus 80 with a pin or rivet connection 485 and is pivotally connected to lock body 472 with a pin or rivet at connection 486. Gripping mechanism 484 includes a moveable jaw 487 and a fixed jaw 488 that is located on the opposite side of the diameter of bore 481 from movable jaw 487.

In operation, cable 432 is pulled out of locking mechanism 400 in a length sufficient to wrap around stanchions 20 or 320 and/or handles 26 in order to secure doors 12. Once the cable has been appropriately wrapped around, first end 460 of cable 432 is inserted into locking mechanism 400 and lock body 472 in the same manner as bolt 32 is inserted. Circumferential taper 464 will push up locking pin 274 until the locking pin encounters circumferential groove 466, and spring 78 will push the locking pin down so that it locks within the circumferential groove.

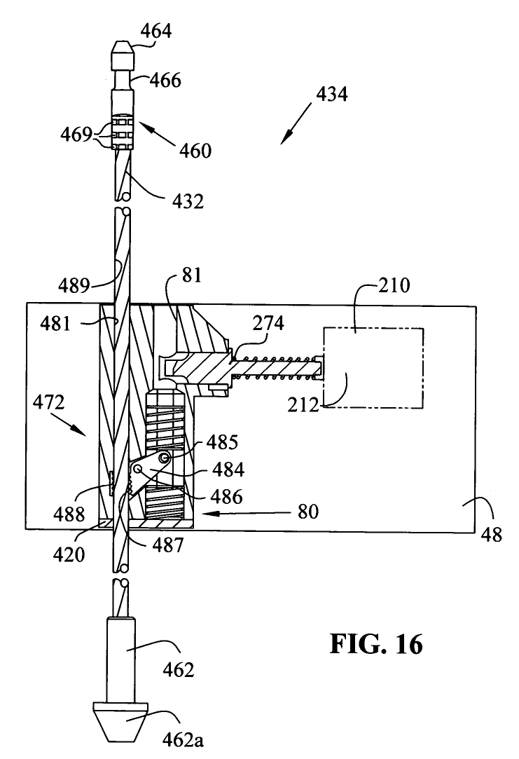

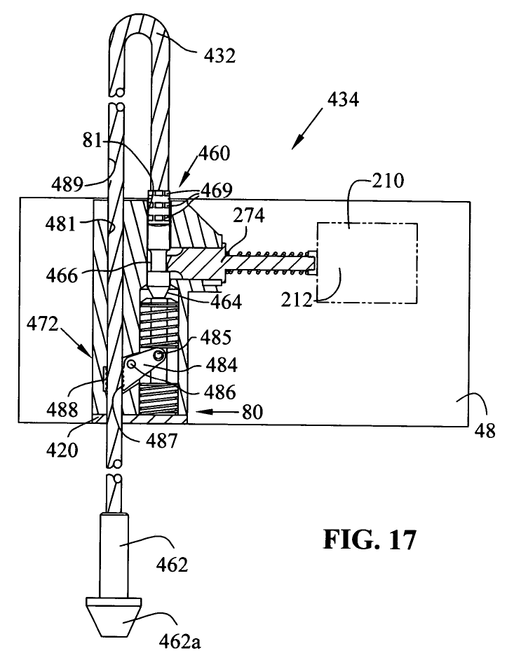

Before end 460 is inserted into lock body 472, moveable jaw 487 is in the position shown in FIG. 16 wherein cable 432 may be pulled freely through bore 481. End 462 is crimped about the cable and enlarged head 462a prevents cable 432 from being completely removed while the jaws are in the position shown in FIG. 16. As end 460 of cable 432 is inserted into lock body 472 into the locked position, it will push biasing apparatus 80 backward against the spring 122. When this happens, moveable jaw 487 will pivot about connection 485 and 486 so that moveable jaw 487 squeezes cable 432 against fixed jaw 488. This precludes the cable from being pulled out any further as shown in FIG. 17. Once locking mechanism 400 is released and end 460 is pushed out of engagement with locking pin 274, an additional length of cable may be pulled from the locking mechanism as moveable jaw 487 returns to the position in FIG. 16.

It should also be appreciated that cable 432 may be fixably attached to the lock body or other portions of locking mechanism 400 so that the length is not adjustable. Additionally, an end 460 may be placed on both ends of cable 432, and the lock body modified so that bore 81 can accommodate both ends 460. This would allow cable 432 to be wrapped about the stanchions and/or door handles and then locked by inserting both ends 460 on the cable into the lock body. Of course, bore 81 and the locking pin would both have to be enlarged to accommodate two ends 460.

While the invention has been taught with specific reference to the foregoing description and drawings, one skilled in the art will recognize that changes may be made in form and detail without departing from the spirit and scope of the invention. For example, although the actuating mechanism uses a solenoid in the above described embodiment, other mechanisms such as a ball screw, a lead screw, a rack and pinion, a linear motor or a double actuating solenoid may be substituted for actuating the locking pin. It should be realized however, that these types of mechanisms may require a different connection at 118 to allow movement of locking pin 74 relative to connecting member 114. As such, a slotted connection could be substituted for connection 118. Also, actuation mechanism 76 may include a mechanical device that is manually actuated by a turn key or such. A special tool may be provided to operate the turn key to prevent unauthorized use. It should also be realized that additional features or options may be added to the locking mechanism such as a tamper indication signal which may provide an audio and/or visible alarm if the unit is tampered with, data acquisition capabilities, such as calculating the time when the bolt is inserted and when it was removed and by what control unit it was removed with. It would also be possible to provide GPS tracking of the locking mechanism by employing a known technology.

Additionally, the specific configurations shown for the locking bolt and locking pin are merely exemplary of one embodiment, and many suitable configurations may be used. For instance, as opposed to a cylindrical configuration, the locking bolt may be triangular, rectangular, hexagonal, etc. In addition, a flexible line or tether may be attached between the end of the bolt and the housing so that when the bolt is removed from the locking mechanism, it does not become displaced. Bolt 32 may also include a head on the second end for use in grasping for removal of the bolt from the locking mechanism. In this case, a fracture line may be included so that if it is attempted to pull and remove the bolt while it is in the locked position, the head will break off at the fracture line. The present invention could also be used with known locking balls or clip style cable seals. Furthermore, the method of manufacture may also be changed so that, for example, the base is stamped as a single piece rather than two portions. Also, other shapes such as circular may be used for the housing. As such, the above embodiment is illustrative only and not restrictive of the invention. Therefore, the scope of the invention is defined by the following claims rather than the description or drawings.

1. A locking mechanism for use on a hasp or other hardware of a door including:
a housing having an opening configured to receive the hasp or hardware;
a locking member that is withdrawable from the locking mechanism, the locking member being insertable through at least a portion of the housing and the hasp or door hardware into a locked position;
a locking pin engageable with the locking member to lock the locking member in the locked position; and
a spring biasing the locking pin in a first direction to lock the locking member.

2. The locking mechanism of claim 1, wherein the locking member has a first end and a second end, and the first end has a tapered surface.

3. The locking mechanism of claim 2, wherein the tapered surface is engageable with the locking pin to push the locking pin in a second direction opposite the first direction so that the locking member may be manually inserted into the locked position.

4. The locking mechanism of claim 2, wherein the locking member is located predominantly within the housing when in the locked position.

5. The locking mechanism of claim 1, further including a second spring biasing the locking member along a longitudinal axis thereof when the locking member is in the locked position.

6. The locking mechanism of claim 5, wherein the second spring pushes the locking member out of the locked position when the locking pin is retracted.

7. The locking mechanism of claim 1, wherein the locking member includes a groove, and a portion of the locking pin is located in the groove when the locking member is in the locked position.

8. The locking mechanism of claim 7, wherein the portion of the locking pin located in the groove has a radiused or chamfered surface.

9. The locking mechanism of claim 1, further including an electro-mechanical device that retracts the locking pin to release the locking member from the locked position when actuated.

10. The locking mechanism of claim 9, wherein the locking member can be manually inserted into the locked position.

11. The locking mechanism of claim 1, wherein the locking pin is substantially perpendicular to the locking member when the locking member is in the locked position.

12. The locking mechanism of claim 11, further including a lock body having bores meeting in a substantially T-shaped configuration, and the locking pin engages the locking member in the bores when the locking member is in the locked position.

13. A locking mechanism for use on a hasp or other hardware of a door including:
a housing having an opening configured to receive the hasp or hardware;
a locking member insertable through at least a portion of the housing and hasp or hardware into a locked position;
a locking pin engageable with the locking member to lock the locking member in the locked position;
a first spring biasing the locking pin in a first direction to lock the locking member; and
a second spring biasing the locking member along a longitudinal axis thereof when the locking member is in the locked position.

14. The locking mechanism of claim 13, wherein when the locking pin is retracted, the second spring pushes the locking member to a position where it may be removed.

15. The locking mechanism of claim 13, further including an electro-mechanical device that retracts the locking pin to release the locking member from the locked position when actuated.

16. The locking mechanism of claim 13, wherein the locking member may be manually inserted into the locked position.

17. The locking mechanism of claim 13, wherein the locking member has first and second ends, the first end being biased by the second spring when the locking member is in the locked position.

18. The locking mechanism of claim 17, wherein the first end includes a tapered surface, the tapered surface being engageable with the locking pin to push the locking pin in a second direction opposite the first direction so that the locking member may be manually inserted into the locked position.

19. The locking mechanism of claim 13, wherein the locking member includes a locking feature, and the locking pin is engaged with the locking feature when the locking member is in the locked position.

20. The locking mechanism of claim 19, wherein the second spring pushes the locking feature into engagement with the locking pin when the locking member is in the locked position.

21. The locking mechanism of claim 20, wherein the locking pin is substantially perpendicular to the locking member when the locking member is in the locked position.

22. A locking mechanism for use on a hasp or other hardware of a door including:
a housing;
a locking member that is insertable through the hasp or hardware into a locked position locking the door; and
an electro-mechanical device mounted to the housing, wherein when the device is actuated, the locking member may be removed from the locked position, and wherein the bolt may be inserted into the locked position without actuating the electro-mechanical device.

23. The locking mechanism of claim 22, wherein the locking member is removable from the locking mechanism.

24. The locking mechanism of claim 22, further including a battery mounted in the housing for providing electric power for actuating the electro-mechanical device.

25. The locking mechanism of claim 22, further including a locking pin engageable with the locking member when the locking member is in the locked position, and wherein the locking pin can be retracted by the electro-mechanical device.

26. The locking mechanism of claim 25, further including a spring biasing the locking pin to lock the locking member.

27. The locking mechanism of claim 26, further including a second spring, and the second spring biases the locking member along a longitudinal axis thereof when the locking member is in the locked position.

28. The locking mechanism of claim 27, wherein the second spring pushes the locking member out of the locked position when the locking pin is retracted.

29. A locking mechanism for use on a hasp or other hardware of a door including:
a housing;
a locking member that is withdrawable from the locking mechanism, the locking member being insertable through the hasp or hardware into a locked position;
a locking pin engageable with the locking member to lock the locking member in the locked position; and
a spring that biases the locking member along a longitudinal axis thereof when the locking member is in the locked position.

30. The locking mechanism of claim 29, wherein the spring pushes the locking member out of the locked position for removal thereof when the locking pin is retracted.

31. The locking mechanism of claim 29, further including an electro-mechanical device mounted to the housing and connected to the locking pin so that the locking pin is retracted when the electro-mechanical device is actuated.

32. The locking mechanism of claim 31, further including a battery mounted in a housing for providing electrical power for actuating the electro-mechanical device.

33. The locking mechanism of claim 32, wherein the locking member has a first end and a second end, and the first end has a tapered surface that is engageable with the locking pin to push the locking pin to a location so that the locking member may be manually inserted into the locked position.

34. The locking mechanism of claim 33, further including an additional spring that biases the locking pin to lock the locking member.

35. The locking mechanism of claim 34, wherein the locking member has a locking feature and the locking pin engages the locking feature when the locking member is in the locked position.

36. The locking mechanism of claim 29, wherein the housing includes a base and a cover, and the base has an opening configured to receive the hasp or hardware.

37. The locking mechanism of claim 36, wherein the housing includes a side wall and at least one internal flange, and the side wall and the flange each have a hole configured to receive the locking member.

38. The locking mechanism of claim 31, further including a battery mounted remotely from the locking mechanism for providing electrical power for actuating the electronic device.

39. The locking mechanism of claim 29, wherein the locking member is a bolt.

40. The locking mechanism of claim 29, wherein the locking member is an end attached to a cable or other flexible material.

41. The locking mechanism of claim 40, wherein a second end of the cable is contained in the locking mechanism, and a length of the cable used to lock the door may be adjusted by pulling a portion of the cable from inside the locking mechanism.

42. The locking mechanism of claim 41, wherein the cable is locked so that an additional length cannot be pulled from the locking mechanism when the first end is inserted into the locked position.

43. The locking mechanism of claim 42, further including a gripping mechanism that locks the cable length pulled from the locking mechanism when the locking member is inserted into the locked position.
